(19) United States
(12) Patent Application Publication
(10) Pub. No.: US 2026/0307266 A1
(43) Pub. Date: Oct. 8, 2026

(54) TASK EXECUTION METHOD, APPARATUS, ROBOT, AND PRODUCT

(71) Applicant: Beijing Youzhuju Network Technology Co., Ltd., Beijing (CN)

(72) Inventor: Wei LI, Beijing (CN)

(21) Appl. No.: 19/539,916

(22) Filed: Feb. 13, 2026

(30) Foreign Application Priority Data
Apr. 3, 2025 (CN) 202510421751.9

(51) Int. Cl. B25J 9/16

(52) U.S. Cl. CPC B25J 9/1697; B25J 9/1612; B25J 9/162; B25J 9/163; B25J 9/1664

(57) ABSTRACT

The present disclosure relates to a task execution method, an apparatus, a robot, and a computer program product. The method is applicable to an intelligent robot. The method includes obtaining a user instruction represented in a natural language, wherein the user instruction indicates an object to be grasped by the intelligent robot; generating, using a language model and based on the user instruction, a movement instruction indicating a position at which the object is located, to cause the intelligent robot to move to the position; obtaining an image obtained at the position; and generating, based on the image, a grasping instruction to cause the intelligent robot to grasp the object.

### CROSS-REFERENCE TO RELATED APPLICATION(S)

This application claims priority to Chinese Application No. 202510421751.9 filed Apr. 3, 2025, the disclosure of which is incorporated herein by reference in its entity.

### FIELD

The present disclosure relates to the field of robots, and more particularly, to a task execution method, an apparatus, a robot, and a product.

### BACKGROUND

With the rapid development of artificial intelligence and robotics, intelligent robots with autonomous mobility and manipulation capabilities are gradually being popularized in various scenarios, including household, commercial, and industrial scenarios. Users expect to send instructions to robots through voice, text, gestures, or the like, and expect robots to accurately understand the content of the instructions, thereby completing corresponding tasks in a current environment.

### SUMMARY

In a first aspect of embodiments of the present disclosure, a task execution method is provided, which is applicable to an intelligent robot. The method includes obtaining a user instruction represented in a natural language, wherein the user instruction indicates an object to be grasped by the intelligent robot; generating, using a language model and based on the user instruction, a movement instruction indicating a position at which the object is located, to cause the intelligent robot to move to the position; obtaining an image obtained at the position; and generating, based on the image, a grasping instruction to cause the intelligent robot to grasp the object.

In a second aspect of embodiments of the present disclosure, a task execution apparatus is provided, which is applicable to an intelligent robot. The apparatus includes a user instruction obtaining module, configured to obtain a user instruction represented in a natural language, wherein the user instruction indicates an object to be grasped by the intelligent robot; a movement instruction generation module, configured to generate, using a language model and based on the user instruction, a movement instruction indicating a position at which the object is located, to cause the intelligent robot to move to the position; an image obtaining module, configured to obtain an image obtained at the position; and a grasping instruction generation module configured to generate, based on the image, a grasping instruction to cause the intelligent robot to grasp the object.

In a third aspect of embodiments of the present disclosure, an electronic device is provided. The electronic device includes one or more processors; and a storage configured to store one or more programs, wherein the one or more programs, when executed by the one or more processors, cause the one or more processors to perform a task execution method applicable to an intelligent robot. The method includes obtaining a user instruction represented in a natural language, wherein the user instruction indicates an object to be grasped by the intelligent robot; generating, using a language model and based on the user instruction, a movement instruction indicating a position at which the object is located, to cause the intelligent robot to move to the position; obtaining an image obtained at the position; and generating, based on the image, a grasping instruction to cause the intelligent robot to grasp the object.

In a fourth aspect of embodiments of the present disclosure, a computer program product is provided. The computer program product is tangibly stored on a non-transitory computer-readable medium and includes machine-executable instructions, wherein the machine-executable instructions, when executed by a machine, cause the machine to perform a task execution method applicable to an intelligent robot. The method includes obtaining a user instruction represented in a natural language, wherein the user instruction indicates an object to be grasped by the intelligent robot; generating, using a language model and based on the user instruction, a movement instruction indicating a position at which the object is located, to cause the intelligent robot to move to the position; obtaining an image obtained at the position; and generating, based on the image, a grasping instruction to cause the intelligent robot to grasp the object.

The Summary section is provided to introduce a selection of concepts in a simplified form, which will be further described in the Detailed Description section below. The Summary section is not intended to identify key features or essential features of the claimed subject matter, nor is it intended to limit the scope of the claimed subject matter.

### BRIEF DESCRIPTION OF THE DRAWINGS

The above and other features, advantages, and aspects of embodiments of the present disclosure will become more apparent in combination with the drawings and with reference to the following detailed description. In the drawings, the same or similar reference symbols refer to the same or similar elements, wherein:

FIG. 1 shows a schematic diagram of an example environment in which a plurality of embodiments of the present disclosure may be implemented;

FIG. 2 shows a flowchart of a task execution method according to some embodiments of the present disclosure;

FIG. 3 shows a schematic diagram of an example of generating a movement instruction using a language model based on a user instruction according to some embodiments of the present disclosure;

FIG. 4 shows a schematic diagram of an example of generating a plurality of movement instructions using a language model based on a user instruction according to some embodiments of the present disclosure;

FIG. 5 shows a schematic diagram of an example of generating a plurality of movement instructions and a plurality of corresponding action instructions using a language model based on a user instruction according to some embodiments of the present disclosure;

FIG. 6 shows a schematic diagram of an example of generating a grasping instruction based on a user instruction and an image according to some embodiments of the present disclosure;

FIG. 7 shows a schematic diagram of an example of generating a grasping instruction based on a user instruction and an image including a plurality of candidate objects according to some embodiments of the present disclosure;

FIG. 8 shows a block diagram of a task execution apparatus according to some embodiments of the present disclosure; and

FIG. 9 shows a block diagram of an intelligent robot capable of implementing a plurality of embodiments of the present disclosure.

### DETAILED DESCRIPTION OF EMBODIMENTS

It may be understood that all user-related data involved in the technical solution should be acquired and used after user authorization. This means that in the technical solution, if user's personal information needs to be used, explicit consent and authorization of the user are required before such data is acquired; otherwise, no related data collection and use will be performed. It should also be understood that when the technical solution is implemented, relevant laws and regulations should be strictly complied with in a process of data collection, use, and storage, and necessary technical means and measures should be taken to ensure user data security and ensure the secure use of data.

Hereinafter, embodiments of the present disclosure will be described in more detail with reference to the drawings. Although some embodiments of the present disclosure are shown in the drawings, it should be understood that the present disclosure may be implemented in various forms and should not be construed as limited to the embodiments set forth herein; on the contrary, these embodiments are provided for a more thorough and complete understanding of the present disclosure. It should be understood that the drawings and embodiments of the present disclosure are only used for illustrative purposes, and are not used to limit the protection scope of the present disclosure.

In the description of the embodiments of the present disclosure, the term “include/comprise” and similar terms thereto should be understood as open-ended inclusions, that is, “include/comprise but not limited to”. The term “based on” should be understood as “at least partially based on”. The term “an embodiment” or “the embodiment” should be understood as “at least one embodiment”. The terms “first”, “second”, and the like may refer to different or same objects, unless explicitly stated. Other explicit and implicit definitions may also be included below.

In the field of intelligent robot technologies, users expect to send natural language instructions to robots in the form of voice or text, for example, “Help me get a bottle of water”, and “Help me get my mobile phone”. To complete these tasks, robots need to have the ability to understand user intentions and the ability to perceive and operate in a real-world environment. In some related technologies, semantic rules or instruction templates may be preset for specific tasks, to convert natural language into specific operation instructions. For example, rule matching is a method based on predefined grammar rules or templates, and a robot may be configured with a predetermined set of templates and use these templates to identify key elements in user sentences. For example, an example template may be “Bring me the [item] at the [position]”. When the user speaks an instruction such as “Bring me the water cup in the kitchen”, the robot may compare the instruction with the template, thereby extracting “kitchen” as the position and the water cup as the object to be grasped.

However, these related technologies cannot deal with ambiguous or irregular user instructions. For example, when a user instruction lacks some key elements, the robot may not be able to complete the task smoothly. For example, when the user instruction is “Bring me the water cup”, the instruction lacks a position element. Therefore, the robot does not know where to grasp the water cup. In the related technologies, to solve this problem, experts need to manually supplement new rules or templates to cover various user instructions. In addition, the experts also need to manually configure the missing information, for example, the water cup may be located on a table in the dining room or in a cabinet in the kitchen. This will increase the resources and time for maintaining the grammar rules or templates, resulting in an increase in the cost of the robot.

In recent years, with the development of deep learning and natural language processing technologies, large language models (LLMs, also referred to as language models herein) have become one of the core technologies for achieving natural language-based human-computer interaction. A large language model is a neural network model with an ultra-large parameter scale that is trained based on massive corpus data. Some examples of large language models may include GPT, DeepSeek, etc. Through unsupervised pre-training on large-scale text data, these models may learn the grammatical structure, semantic rules, and contextual associations of languages, and have powerful language understanding and generation capabilities. Different from traditional natural language processing methods that rely on rules or shallow semantic parsing, large language models may automatically infer user intentions, understand complex sentences, and process context-dependent information without explicit rules. In addition, large language models also have a certain degree of logical reasoning and knowledge generalization capabilities.

The introduction of large language models enables robot systems to achieve a leap from “keyword recognition” to “semantic understanding and reasoning” in language understanding, greatly improving the natural language processing capabilities of the systems, and laying a foundation for language-driven task execution systems.

To this end, embodiments of the present disclosure provide a task execution solution, which is applicable to intelligent robots. In this solution, a robot may obtain a user instruction represented in a natural language, wherein the user instruction indicates an object to be grasped by the robot. Then, the robot may generate, using a language model and based on the user instruction, a movement instruction indicating a position at which the object is located, to cause the robot to move to the position. Then, the robot may obtain an image obtained at the position. Then, the robot may generate, based on the image, a grasping instruction to grasp the object.

In this way, the natural language processing capability of the robot may be improved by using the understanding capability of the language model, so that the robot may deal with user instructions in various expressions. In this way, users may express their needs more naturally. In addition, by using the reasoning capability of the language model, the robot may deal with user instructions lacking necessary elements, so that users may communicate with the robot in the way they communicate with humans, without having to make sure that the instruction includes all necessary elements before speaking the instruction to the robot. In this way, the solution may not only reduce the cost of enabling the robot to understand the meaning of the user instruction, but also improve the user experience.

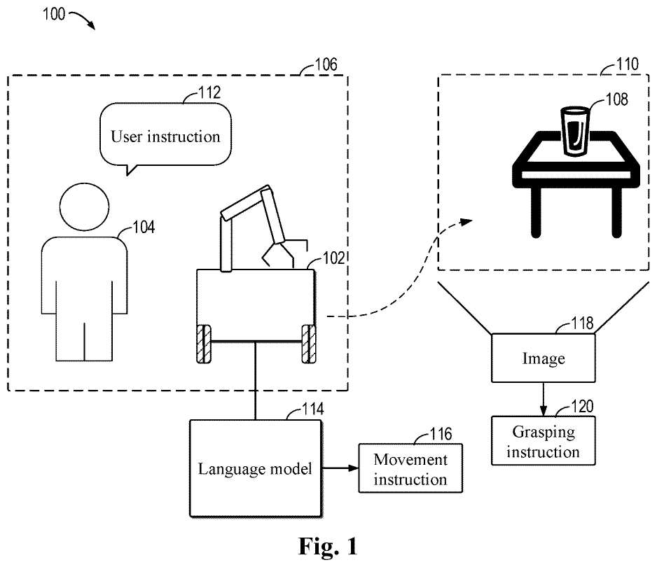

FIG. 1 shows a schematic diagram of an example environment 100 in which a plurality of embodiments of the present disclosure may be implemented. As shown in FIG. 1, the environment 100 includes a robot 102, wherein the robot 102 may be equipped with various hardware or sensors. For example, the robot 102 may have a language interaction module, a motion control and navigation module, a visual perception and recognition module, a grasping execution module, and a control and communication module. The control and communication module may include a controller and a wireless communication module. The controller may be any control unit having a processing capability or a computing capability. The controller may be configured to control various subsystems of the robot 102, schedule tasks, fuse sensor data, and make behavior decisions. The wireless communication module may include, for example, a Wi-Fi module or a Bluetooth module. The wireless communication module may be configured to communicate with a user device, a cloud server, or another device.

The language interaction module may include a microphone array or a voice receiver, and a speaker. The microphone array or the voice receiver may be configured to acquire voice instructions of a user, and may further support functions such as voice recognition and noise suppression. The speaker may be configured to perform voice interaction with the user (for example, ask clarifying questions).

The motion control and navigation module may include a mobile chassis, a wheel encoder, an inertial measurement unit, a lidar, a depth camera, a navigation control unit, etc. The mobile chassis may be, for example, a differential drive chassis or an omnidirectional wheel chassis. When the robot 102 is a humanoid robot, the mobile chassis may be legs and feet of the robot. The mobile chassis may support the robot 102 in autonomous navigation on the ground. The wheel encoder and the inertial measurement unit may be used to achieve motion state perception and attitude estimation. The lidar and the depth camera may support a simultaneous localization and mapping (SLAM) function for mapping and obstacle avoidance. The navigation control unit may cause the robot 102 to move to a position indicated by a movement instruction by converting the movement instruction into an executable path instruction.

The visual perception and recognition module may include a red green blue (RGB) camera or an RGB-depth (RGB-D) camera, an image processing unit, and a depth map perception module. The RGB camera or the RGB-D camera may be configured to acquire an environment image after the robot 102 reaches a target position. The environment image may be, for example, a color image or a depth image. The image processing unit may use an object detection model, an image segmentation model, etc. to recognize a position of a target object in the image. The depth map perception module may be used to calculate a three-dimensional position and attitude of the target object for determining a grasping action.

The grasping execution module may include a robotic arm, an end effector, and a tactile sensor. The robotic arm and the end effector may support spatial movement for performing grasping actions. The tactile sensor may be used to determine whether an object is successfully grasped, and to monitor a contact state between the end effector and the target object.

In the environment 100, a user 104 and the robot 102 may be located at a position 106 (for example, a living room, a bedroom, etc.). The user 104 may input, to the robot 102, a user instruction 112 represented in a natural language, wherein the user instruction 112 indicates an object that needs to be grasped by the robot 102. For example, the user instruction 112 may be “Help me get a water cup”, wherein the object that needs to be grasped is the water cup. The user instruction 112 may also be “Get my history book for me”, wherein the object that needs to be grasped is a book. The user instruction 112 may be voice or text. In some embodiments, the user 104 may speak the user instruction 112 to the robot. In some embodiments, the user 104 may input the user instruction 112 through a user device or a user interaction interface of the robot 102. In some embodiments, the user 104 may input the user instruction 112 by selecting a control displayed on the user interaction interface of the robot 102.

In the environment 100, the robot 102 may invoke a language model 114. The language model 114 may be deployed locally on the robot 102. For example, the language model 114 may be deployed in the controller of the robot 102. The language model 114 may alternatively be deployed in a cloud server. The robot 102 may invoke the language model 114 by communicating with the cloud server using the wireless communication module. The language model 114 is a deep learning-based natural language processing model that may understand natural language and generate high-quality coherent text by learning massive text data and capturing the grammar, semantics, and contextual relationships of the language. For example, a technique for implementing the language model 114 may be based on a transformer (Transformer) architecture, in which a self-attention mechanism is used to analyze associations between words and sentences in input text, to recognize deep structures in the language. The language model 114 may be a large language model, such as GPT, DeepSeek, etc.

In the environment 100, the robot 102 may generate, using the language model 114 and based on the user instruction 112, a movement instruction 116 indicating a position at which the object to be grasped is located. For example, the movement instruction 116 may indicate moving to a position 110. In the example wherein the user instruction 112 is “Help me get a water cup”, the object to be grasped is the water cup. However, the user instruction 112 does not explicitly indicate the position at which the water cup is located. By using the understanding and reasoning capabilities of the language model 114, the robot 102 may infer that the object 108 to be grasped may be found at the position 110 (for example, a dining room). Therefore, the robot 102 may input the user instruction into the language model 114. The language model 114 may generate the movement instruction 116 based on the user instruction 112. Then, the robot 102 may move from the position 106 to the position 110 (for example, move from the bedroom to the dining room) based on the movement instruction 116.

In the environment 100, after moving to the position 110, the robot 102 may use a camera to take pictures of the surrounding environment at the position 110 to obtain an image 118, wherein the image 118 includes the object 108 to be grasped. For example, after moving to a certain position in the dining room, the robot 102 may use the camera to take a picture of the dining room to obtain an image of the dining room. In the image, the water cup is placed on a table.

In the environment 100, the robot 102 may generate a grasping instruction 120 based on the image 118, and grasp the object 108 based on the grasping instruction 120. In some embodiments, the robot 102 may use an object detection model to recognize the object 108 in the image 118, and determine a position of the object 108. Then, the robot 102 may generate the corresponding grasping instruction 120 based on the determined position of the object 108. In some embodiments, the robot 102 may use the language model 114 (or another language model) to generate the grasping instruction 120. For example, the robot 102 may input the image 118 into the language model 114, to cause the language model 114 to generate the grasping instruction 120 based on the image 118. Then, the robot 102 may grasp the object 108 based on the generated grasping instruction 120, return to the position 106, and deliver the object 108 to the user 104.

In this way, the natural language processing capability of the robot 102 may be improved by using the understanding capability of the language model 114, so that the robot 102 may deal with the user instruction 112 in various expressions. In this way, the user 104 may express his/her needs more naturally. In addition, by using the reasoning capability of the language model 114, the robot 102 may deal with user instructions lacking necessary elements, so that the user 104 may communicate with the robot 102 in the way he/she communicates with humans, without having to make sure that the instruction includes all necessary elements before speaking the instruction to the robot 102. In this way, the solution may not only reduce the cost of enabling the robot 102 to understand the meaning of the user instruction, but also improve the user experience.

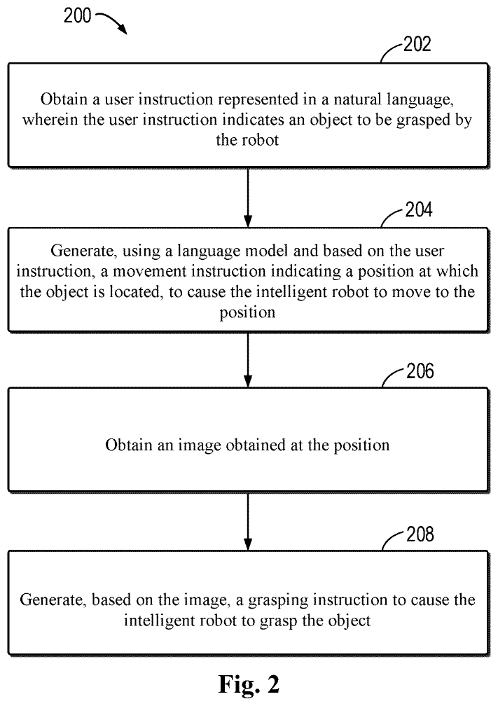

FIG. 2 shows a flowchart of a task execution method 200 according to some embodiments of the present disclosure. The method 200 may be performed by an intelligent robot or a controller of the robot. For example, the method 200 may be performed by the robot 102 or the controller of the robot 102 in FIG. 1. As shown in FIG. 2, at a block 202, the robot may obtain a user instruction represented in a natural language, wherein the user instruction indicates an object to be grasped by the robot. For example, in the environment 100 shown in FIG. 1, a user 104 and the robot 102 may be located at a position 106 (for example, a living room, a bedroom, etc.). The user 104 may input, to the robot 102, a user instruction 112 represented in a natural language, wherein the user instruction 112 indicates an object that needs to be grasped by the robot 102. For example, the user instruction 112 may be “Help me get a water cup”, wherein the object that needs to be grasped is the water cup. The user instruction 112 may also be “Get my history book for me”, wherein the object that needs to be grasped is a book. The user instruction 112 may be voice or text. In some embodiments, the user 104 may speak the user instruction 112 to the robot. In some embodiments, the user 104 may input the user instruction 112 through a user device or a user interaction interface of the robot 102. In some embodiments, the user 104 may input the user instruction 112 by selecting a control displayed on the user interaction interface of the robot 102.

At a block 204, the robot may generate, using a language model and based on the user instruction, a movement instruction indicating a position at which the object is located, to cause the robot to move to the position. For example, in the environment 100 shown in FIG. 1, the robot 102 may invoke a language model 114. The language model 114 may be deployed locally on the robot 102. For example, the language model 114 may be deployed in the controller of the robot 102. The language model 114 may alternatively be deployed in a cloud server. The robot 102 may invoke the language model 114 by communicating with the cloud server using a wireless communication module. The language model 114 is a deep learning-based natural language processing model that may understand natural language and generate high-quality coherent text by learning massive text data and capturing the grammar, semantics, and contextual relationships of the language. The language model 114 may be, for example, a large language model such as GPT, DeepSeek. The robot 102 may generate, using the language model 114 and based on the user instruction 112, a movement instruction 116 indicating a position at which the object to be grasped is located. For example, the movement instruction 116 may indicate moving to a position 110. In the example wherein the user instruction 112 is “Help me get a water cup”, the object to be grasped is the water cup. However, the user instruction 112 does not explicitly indicate the position at which the water cup is located. By using the understanding and reasoning capabilities of the language model 114, the robot 102 may infer that the object 108 to be grasped may be found at the position 110 (for example, a dining room). Therefore, the robot 102 may input the user instruction into the language model 114. The language model 114 may generate the movement instruction 116 based on the user instruction 112. Then, the robot 102 may move from the position 106 to the position 110 (for example, move from a bedroom to the dining room) based on the movement instruction 116.

At a block 206, the robot may obtain an image obtained at the position. For example, in the environment 100 shown in FIG. 1, after moving to the position 110, the robot 102 may use a camera to take pictures of the surrounding environment at the position 110 to obtain an image 118, wherein the image 118 includes the object 108 to be grasped. For example, after moving to a certain position in the dining room, the robot 102 may use the camera to take a picture of the dining room to obtain an image of the dining room. In the image, the water cup is placed on a table.

At a block 208, the robot may generate, based on the image, a grasping instruction to cause the robot to grasp the object. For example, in the environment 100 shown in FIG. 1, the robot 102 may generate a grasping instruction 120 based on the image 118, and grasp the object 108 based on the grasping instruction 120. In some embodiments, the robot 102 may use an object detection model to recognize the object 108 in the image 118, and determine a position of the object 108. Then, the robot 102 may generate the corresponding grasping instruction 120 based on the determined position of the object 108. In some embodiments, the robot 102 may use the language model 114 (or another language model) to generate the grasping instruction 120. For example, the robot 102 may input the image 118 into the language model 114, to cause the language model 114 to generate the grasping instruction 120 based on the image 118. Then, the robot 102 may grasp the object 108 based on the generated grasping instruction 120, return to the position 106, and deliver the object 108 to the user 104.

In this way, the natural language processing capability of the robot may be improved by using the understanding capability of the language model, so that the robot may deal with user instructions in various expressions. In this way, users may express their needs more naturally. In addition, by using the reasoning capability of the language model, the robot may deal with user instructions lacking necessary elements, so that users may communicate with the robot in the way they communicate with humans, without having to make sure that the instruction includes all necessary elements before speaking the instruction to the robot. In this way, the solution may not only reduce the cost of enabling the robot to understand the meaning of the user instruction, but also improve the user experience.

In some embodiments, when generating the movement instruction using the language model, the robot may generate, based on the user instruction, a prompt for the language model. Then, the robot may generate the movement instruction by inputting the prompt into the language model. In some embodiments, the robot may obtain a task description and an output template. Then, the robot may generate the prompt based on the task description, the user instruction, and the output template. In some embodiments, the movement instruction includes a coordinate of the position. The controllability and stability of the output of the language model may be improved by constructing the prompt. In addition, by including the task intention and the template structure in the prompt, the format consistency and accuracy of the output of the language model may be improved, so that it may be ensured that the generated movement instruction has a standard structure and is easy to parse and execute, and the possibility of errors of downstream modules may be reduced.

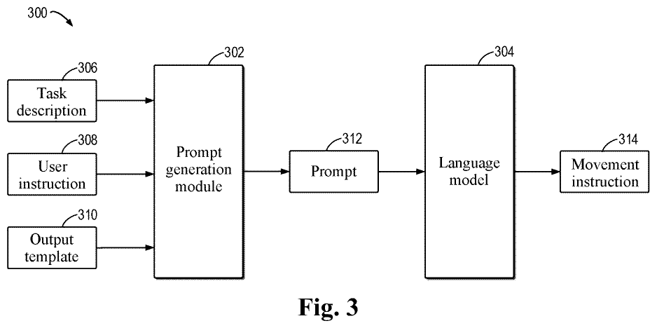

FIG. 3 shows a schematic diagram of an example 300 of generating, using a language model and based on a user instruction, a movement instruction according to some embodiments of the present disclosure. As shown in FIG. 3, the example 300 includes a prompt generation module 302 and a language model 304, wherein the language model 304 may be, for example, the language model 114 in FIG. 1. In the example 300, the robot may obtain a predetermined task description 306 and a predetermined output template 310. The task description 306 is used to prompt the language model 304 to generate an output based on the user instruction 308 (for example, the user instruction 112 in FIG. 1), and the output should include a movement instruction indicating that the robot moves to the position at which the object to be grasped is located. The output template 310 is used to define the format of the output of the language model 304. In some embodiments, the output template 310 may further include an output example, so that the language model 304 may better understand the output template 310, and the accuracy of the generated output may be improved. In some embodiments, the output template 310 may further include reasoning description, which is used to require the language model 304 to explain the reason for moving to the position. The reasoning logic of the language model 304 may be enhanced by letting the language model 304 output the explanation, thereby improving the accuracy of the output content.

In the example 300, the prompt generation module 302 may generate a prompt 312 based on the task description 306, the user instruction 308, and the output template 310. An example of the generated prompt 312 when the user instruction 308 is “Help me get a water cup” is shown below:
“Task description”
You are a robot assistant. Your task is to determine, based on a natural language instruction from a user, which room to move to, to prepare for a subsequent grasping operation. You need to perform reasonable reasoning based on common sense and instruction content, and output a structured “movement instruction”.
“User instruction”
Help me get a water cup.
“Output template”
Please output the movement instruction in the following format:
{
   “Action”: “Navigate”,
   “Target position”: “<target position, for example: kitchen/dining room/bedroom/living room/etc.>”,
   “Reasoning description”: “<reasoning description, explaining why the target position is selected>”
}

In the example 300, the generated prompt 312 may be input to the language model 304. The language model 304 may output content based on the prompt 312, and the output content may include a movement instruction 314. The movement instruction 314 may indicate the position at which the object to be grasped is located. For example, an example of the movement instruction 314 is shown below:
{
   “Action”: “Navigate”,
   “Target position”: “Dining room”,
   “Reasoning description”: “It is inferred from the user instruction that the water cup is usually placed in the dining room or the kitchen. Considering the semantic information of the current environment, the dining room is prioritized.”
}

In some embodiments, the output template 310 may further define that the output target position includes a coordinate. In this way, the movement instruction 314 may include a specific coordinate value, for example, the dining room (x, y). In this way, the robot may navigate to the target position based on the coordinate values in the movement instruction 314.

In some embodiments, the movement instruction is a first movement instruction, the position is a first position, and when the movement instruction indicating the position at which the object is located is generated using the language model, the robot may generate, using the language model and based on the user instruction, a plurality of movement instructions, wherein the plurality of movement instructions include the first movement instruction and a second movement instruction, the second movement instruction indicates a second position at which the object is located, and the second movement instruction is used to cause the robot to move to the second position to grasp the object in response to the robot failing to grasp the object at the first position. In this way, additional inquiries with the user by the robot due to the failure to find the object at the first position may be avoided, thereby improving the coherence and intelligence of human-robot interaction. In addition, this way may increase the success rate of completing tasks and enhance the robustness of task execution.

In some embodiments, the task description may prompt the language model to generate a plurality of movement instructions. The robot may obtain a predetermined sorting strategy. Then, the robot may generate the prompt based on the task description, the sorting strategy, the user instruction, and the output template. In this way, the language model may be caused to generate movement instructions for a plurality of target positions based on a set priority. By embedding the sorting strategy into the prompt construction process, the practicability and controllability of the output result of the language model and the success rate of completing tasks may be improved, thereby further enhancing the planning capability and interaction performance of the robot in a complex environment.

In some embodiments, the sorting strategy may be sorting the plurality of movement instructions based on a probability of the object appearing at a corresponding position. In this way, the success rate of completing the task may be improved. In some embodiments, the sorting strategy may be sorting the plurality of movement instructions based on path planning for a plurality of positions corresponding to the plurality of movement instructions. In this way, the average moving time may be reduced and energy consumption may be saved.

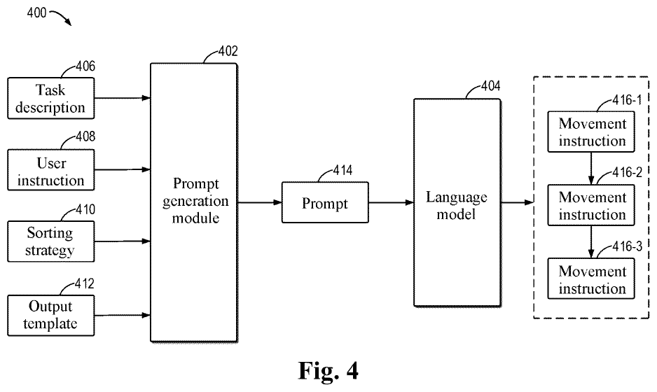

FIG. 4 shows a schematic diagram of an example 400 of generating a plurality of movement instructions using a language model based on a user instruction according to some embodiments of the present disclosure. As shown in FIG. 4, the example 400 includes a prompt generation module 402 and a language model 404, wherein the language model 404 may be, for example, the language model 114 in FIG. 1. In the example 400, the robot may obtain a predetermined task description 406, a predetermined sorting strategy 410, and a predetermined output template 412. The task description 406 is used to prompt the language model 404 to generate an output based on the user instruction 408 (for example, the user instruction 112 in FIG. 1), and the output should include a plurality of movement instructions, wherein the plurality of movement instructions are sorted based on the sorting strategy 410. The output template 412 is used to define the format of the output of the language model 404. In some embodiments, the output template 412 may further include an output example, so that the language model 404 may better understand the output template 412, and the accuracy of the generated output may be improved. In some embodiments, the output template 412 may further include reasoning description, which is used to require the language model 404 to explain the reason for moving to the position. The reasoning logic of the language model 404 may be enhanced by letting the language model 404 output the explanation, thereby improving the accuracy of the output content.

In the example 400, the prompt generation module 402 may generate a prompt 414 based on the task description 406, the user instruction 408, the sorting strategy 410, and the output template 412. An example of the generated prompt 414 when the user instruction 408 is “Help me get a water cup” is shown below:
“Task description”
You are a service robot. Your task is to generate, based on a natural language instruction from a user, a plurality of possible movement instructions, to go to a position at which a target object may be located. You need to sort these positions based on a probability or rationality of the object usually appearing. You will output the plurality of movement instructions, and sort them based on a sorting strategy, to preferentially try the position most likely to succeed.
“User instruction”
Help me get a water cup.
“Sorting strategy”
Please sort a plurality of target positions based on the following principles:
   Determine, based on common sense, a position at which the water cup is most likely to appear;
   Sort in an order of “a probability of finding the target object from high to low”; and
   Explain in each movement instruction your reason for sorting the position.
“Output template”
Please output a plurality of movement instructions (it is recommended to output 2 to 3 movement instructions) in the following JSON structure:
[
   {
      “Order”: <number, indicating the order, for example, 1 indicates the highest priority>,
      “Action”: “Navigate”,
      “Target position”: “<target position, for example: kitchen/dining room/bedroom/living room/etc.>”,
      “Reasoning description”: “<why you choose this position and rank it in the current order>”
   },
   . . .
]

In the example 400, the generated prompt 414 may be input to the language model 404. The language model 404 may output content based on the prompt 414, and the output content may include movement instructions 416-1, 416-2, and 416-3. The movement instructions 416-1, 416-2, and 416-3 may indicate possible positions at which the object to be grasped is located. The movement instructions 416-1, 416-2, and 416-3 are sorted based on the priority, wherein the movement instruction 416-1 has a higher priority than the movement instruction 416-2, and the movement instruction 416-2 has a higher priority than the movement instruction 416-3. For example, an example of the movement instructions 416-1, 416-2, and 416-3 is shown below:
[
   {
      “Order”: 1,
      “Action”: “Navigate”,
      “Target position”: “Dining room”,
      “Reasoning description”: “The water cup is usually placed near the dining table, and the user may be having a meal, so the dining room is prioritized.”
   },
   {
      “Order”: 2,
      “Action”: “Navigate”,
      “Target position”: “Kitchen”,
      “Reasoning description”: “The kitchen is also a place where the water cup is often placed, and it may have just been washed and not taken out yet.”
   },
   {
      “Order”: 3,
      “Action”: “Navigate”,
      “Target position”: “Bedroom”,
      “Reasoning description”: “Some users are accustomed to placing the water cup on the tea table in the living room, so this is considered as the third option.”
   }
]

After generating the movement instructions 416-1, 416-2, and 416-3, the robot may first move to the position (for example, the dining room) indicated by the movement instruction 416-1, and then take an image of the surrounding environment. The robot may recognize whether there is an object that needs to be grasped in the image. If there is the object, the robot may grasp the object and deliver it to the user. If there is no object, the robot may continue to move to the position (for example, the kitchen) indicated by the movement instruction 416-2, and then take an image of the surrounding environment. The robot may recognize whether there is an object that needs to be grasped in the image. If there is the object, the robot may grasp the object and deliver it to the user. If there is no object, the robot may continue to move to the position (for example, the bedroom) indicated by the movement instruction 416-3, and then take an image of the surrounding environment, and so on.

In practical applications, the robot usually needs to perform some auxiliary actions before grasping the object, such as opening a cabinet door, a drawer, a refrigerator, or moving an obstacle. In some embodiments, the robot may generate, using the language model and based on the user instruction, an action instruction associated with the movement instruction, to cause the robot to perform a specified action included in the action instruction after moving to the position and before grasping the object. The robot may complete an intermediate step associated with the task context by using the language model to generate the action instruction associated with the position. In this way, the task adaptability of the robot in a real scenario may be enhanced. In addition, this way may also improve the implicit steps in the user instruction, so that the understanding capability of an indirect user instruction may be improved, and the success rate of completing the task may be increased.

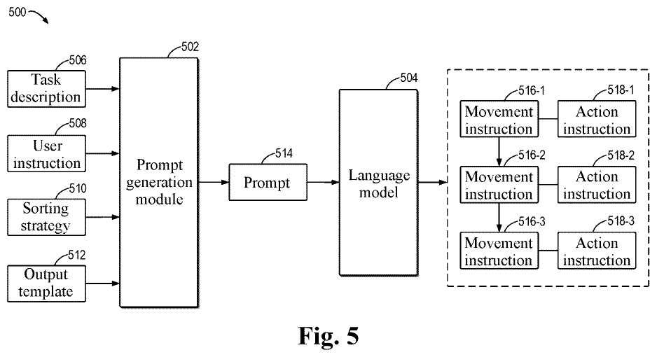

FIG. 5 shows a schematic diagram of an example 500 of generating, using a language model and based on a user instruction, a plurality of movement instructions and a plurality of corresponding action instructions according to some embodiments of the present disclosure. As shown in FIG. 5, the example 500 includes a prompt generation module 502 and a language model 504, wherein the language model 504 may be, for example, the language model 114 in FIG. 1. In the example 500, the robot may obtain a predetermined task description 506, a predetermined sorting strategy 510, and a predetermined output template 512. The task description 506 is used to prompt the language model 504 to generate an output based on the user instruction 508 (for example, the user instruction 112 in FIG. 1). The output should include a plurality of movement instructions and an action instruction associated with each movement instruction, wherein the plurality of movement instructions are sorted based on the sorting strategy 510, and the action instruction indicates a specified action that the robot needs to perform after moving to the target position and before grasping the object. The output template 512 is used to define the format of the output of the language model 504. In some embodiments, the output template 512 may further include an output example, so that the language model 504 may better understand the output template 512, and the accuracy of the generated output may be improved. In some embodiments, the output template 512 may further include reasoning description, which is used to require the language model 504 to explain the reason for moving to the position. The reasoning logic of the language model 504 may be enhanced by letting the language model 504 output the explanation, thereby improving the accuracy of the output content.

In the example 500, the prompt generation module 502 may generate a prompt 514 based on the task description 506, the user instruction 508, the sorting strategy 510, and the output template 512. An example of the generated prompt 514 when the user instruction 508 is “Help me get a water cup” is shown below:
“Task description”
You are a service robot. A user will give you a natural language instruction (for example, “Help me get a water cup”). You need to infer a plurality of possible target positions based on the user instruction, and generate one movement instruction for each position. After the robot moves to the position, before grasping the target object, an action instruction associated with the position needs to be executed. For example: open a cabinet door, look around, push away obstacles, etc. Please generate a corresponding action instruction for each movement instruction based on the task semantics and common sense.
“User instruction”
Help me get a water cup.
“Sorting Strategy”
Please sort a plurality of target positions based on the following principles:
   Determine, based on common sense, a position at which the water cup is most likely to appear;
   Sort in an order of “a probability of finding the target object from high to low”; and
   Explain in each movement instruction your reason for sorting the position.
“Output template”
Please output a plurality of target positions, each including a movement instruction and a plurality of action instructions, in the following JSON structure:
[
   {
      “Order”: <number, indicating the order, 1 indicates the highest priority>,
      “Movement instruction”: {
         “Action”: “Navigate”,
         “Target position”: “<target position, for example: kitchen/dining room/bedroom/living room/etc.>”,
         “Reasoning description”: “<why you choose this position and rank it in the current order>”
      },
      “Action instruction”: {
         “Action”: “<auxiliary action executed at the position, for example: open a cabinet, scan a specific area, adjust a camera angle, etc.>”,
         “Reasoning description”: “<why the action needs to be executed at the position>”
      }
   },
   . . .
]

In the example 500, the generated prompt 514 may be input to the language model 504. The language model 504 may output content based on the prompt 514, and the output content may include movement instructions 516-1, 516-2, and 516-3. The movement instructions 516-1, 516-2, and 516-3 may indicate possible positions at which the object to be grasped is located. The output content may further include action instructions 518-1, 518-2, and 518-3. The action instruction 518-1 is associated with the movement instruction 516-1, the action instruction 518-2 is associated with the movement instruction 516-2, and the action instruction 518-3 is associated with the movement instruction 516-3. The movement instructions 516-1, 516-2, and 516-3 are sorted based on the priority, wherein the movement instruction 516-1 has a higher priority than the movement instruction 516-2, and the movement instruction 516-2 has a higher priority than the movement instruction 516-3. For example, an example of the movement instructions 516-1, 516-2, and 516-3 is shown below:
[
   {
      “Order”: 1,
      “Movement instruction”: {“Action”: “Navigate”,
         “Target position”: “Dining room”,
         “Reasoning description”: “The water cup is usually placed near the dining table, and the user may be dining, so the dining room is prioritized.”
      },
      “Action instruction”: {“Reasoning description”:
         “Action”: “Scan the dining table”,
         “To recognize an object on the dining table, the robot needs to perform visual scanning on the table.”
      }
   },
   {
      “Order”: 2,
      “Movement instruction”: {“Action”: “Navigate”,
         “Target position”: “Kitchen”,
         “Reasoning description”: “The water cup is also often placed in the kitchen sink or cabinet, so the kitchen is the second possible position.”
      },
      “Action instruction”:
         {“Action”: “Open the cabinet”,
      “Reasoning description”: “The water cup may be placed in the cabinet, and the cabinet door needs to be opened to check.”
      }
   },
   {
      “Order”: 3,
      “Movement instruction”: {
         “Action”: “Navigate”,
         “Target position”: “Bedroom”,
      “Reasoning description”: “Some users like to drink water in the living room, and the water cup may be on the tea table, so the living room is considered as the third option.”
      },
      “Action instruction”: {
         “Action”: “Scan the tea table”,
         “Reasoning description”: “The tea table is the most likely position for placing the water cup in the living room, so the tea table area needs to be mainly observed.”
      }
   }
]

After generating the movement instructions 516-1, 516-2, and 516-3 and the action instructions 518-1, 518-2, and 518-3, the robot may first move to the position (for example, the dining room) indicated by the movement instruction 516-1, execute the action instruction 518-1 (for example, scan the dining table), and then take an image of the surrounding environment. The robot may recognize whether there is an object that needs to be grasped in the image. If there is the object, the robot may grasp the object and deliver it to the user. If there is no object, the robot may continue to move to the position (for example, the kitchen) indicated by the movement instruction 516-2, execute the action instruction 518-2 (for example, open the cabinet), and then take an image of the surrounding environment. The robot may recognize whether there is an object that needs to be grasped in the image. If there is the object, the robot may grasp the object and deliver it to the user. If there is no object, the robot may continue to move to the position (for example, the bedroom) indicated by the movement instruction 516-3, execute the action instruction 518-3 (for example, scan the tea table), and then take an image of the surrounding environment, and so on.

In some embodiments, the user instruction may include an attribute (for example, a color, a shape, a size, etc.) of the object. For example, the user instruction may be “Help me get a green water cup”, wherein the user specifies that the color attribute of the water cup is green. In some embodiments, the robot may determine, using the language model and based on the user instruction, the attribute of the object. Then, the robot may generate the grasping instruction based on the image and the attribute of the object. In some embodiments, the object is a target object, and the robot may determine a category of the target object. The robot may determine a candidate object in the image based on the category of the target object. The robot may determine a value of an attribute of the candidate object. Then, the robot may generate, in response to determining that the value of the attribute of the candidate object matches a value of the attribute specified in the user instruction, the grasping instruction by determining the candidate object as the target object. In this way, the robot may narrow down the recognition range by filtering attributes of objects, thereby improving the target positioning accuracy, reducing erroneous grasping, and improving the grasping accuracy.

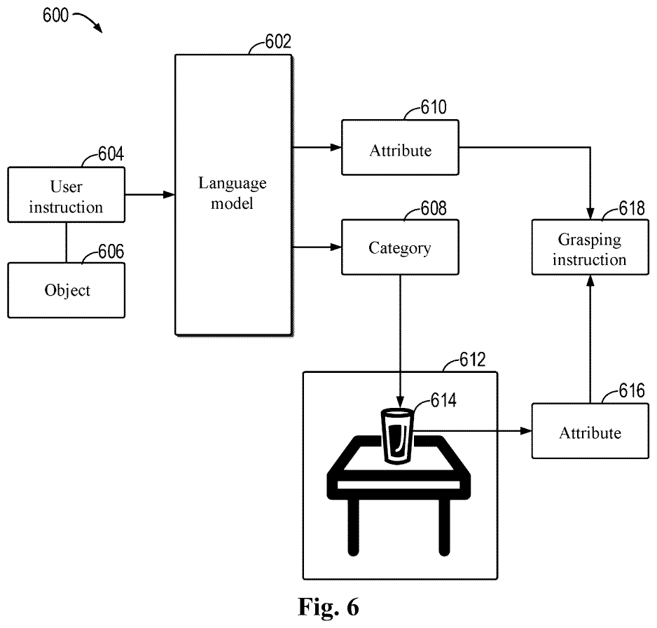

FIG. 6 shows a schematic diagram of an example 600 of generating a grasping instruction based on a user instruction and an image according to some embodiments of the present disclosure. As shown in FIG. 6, the example 600 includes a language model 602 (for example, the language model 114 in FIG. 1). The language model 602 may output, based on the user instruction 604, a category 608 and an attribute 610 of an object 606 to be grasped that are indicated in the user instruction 604. For example, the user instruction 604 may be “Help me get a green water cup”, wherein the object 606 is the water cup. The language model 602 may receive a prompt including the user instruction 604, and output the category (for example, a cup) and the attribute (that is, green) of the water cup. Then, the robot may move to the target position, and use a camera to capture an image 612 of the surrounding environment, wherein the image 612 includes an object 614 (for example, a water cup). The robot may recognize the object 614 having the category 608 in the image 612, and recognize an attribute 616 of the object 614. Then, the robot may compare a value of the attribute 610 with a value of the attribute 616. When the robot determines that the value of the attribute 610 is the same as the value of the attribute 616, a grasping instruction 618 may be generated to grasp the object 614.

In some embodiments, the image of the surrounding environment may include a plurality of objects that meet the attribute requirement. To reduce the number of times the robot returns to the user to ask which object to grasp, the robot may determine a category of the target object. The robot may determine a plurality of candidate objects in the image based on the category of the target object and the value of the attribute specified in the user instruction. Then, the robot may generate, using a second language model and based on the user instruction and the image, the grasping instruction, wherein the grasping instruction includes the target object determined from the plurality of candidate objects. In this way, the disturbance to the user may be reduced, the continuity of the task may be improved, and the user experience may be improved.

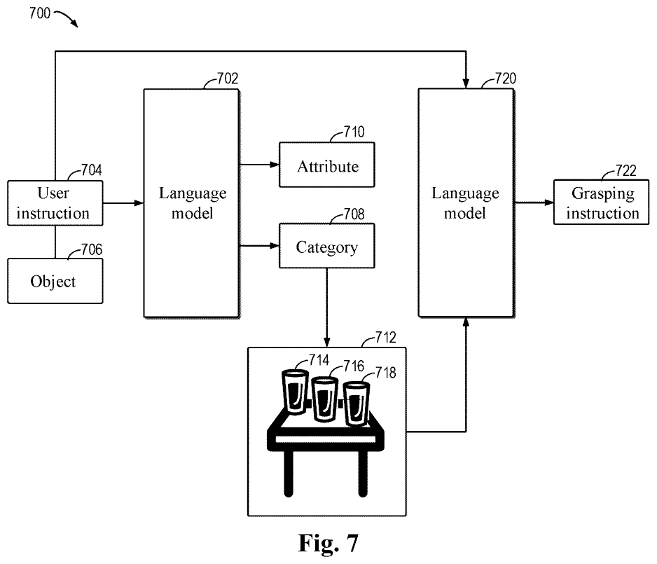

FIG. 7 shows a schematic diagram of an example 700 of generating a grasping instruction based on a user instruction and an image including a plurality of candidate objects according to some embodiments of the present disclosure. As shown in FIG. 7, the example 700 includes a language model 702 (for example, the language model 114 in FIG. 1) and a language model 720, which may be the same language model or different language models. The language model 702 may output, based on the user instruction 704, a category 708 and an attribute 710 of an object 706 to be grasped that are indicated in the user instruction 704. For example, the user instruction 704 may be “Help me get a green water cup”, wherein the object 706 is the water cup. The language model 702 may receive a prompt including the user instruction 704, and output the category (for example, a cup) and the attribute (that is, green) of the water cup. Then, the robot may move to the target position, and use a camera to capture an image 712 of the surrounding environment, wherein the image 712 includes objects 714, 716, and 718 (for example, three water cups). The robot may recognize the objects 714, 716, and 718 having the category 708 in the image 712, and recognize attributes of the objects 714, 716, and 718. Then, the robot may compare the value of the attribute 710 with attribute values of the objects 714, 716, and 718. The robot may determine that the objects 714, 716, and 718 all match the attribute 710 (for example, they are all green water cups).

To determine the target object to be grasped, the robot may input the image 712 and the user instruction 704 into the language model 720. The language model 720 may recommend one of the objects 714, 716, and 718 (for example, the object 714) as the target object to be grasped based on the image 712 and the user instruction 704, and generate a grasping instruction 722 for grasping the target object. Then, the robot may grasp the target object based on the grasping instruction 722, and deliver it to the user.

In this way, the robot does not need to return to the user and ask the user which one of the objects 714, 716, and 718 to grasp. This may reduce the time of movement, improve the efficiency of completing the task, and improve the user experience.

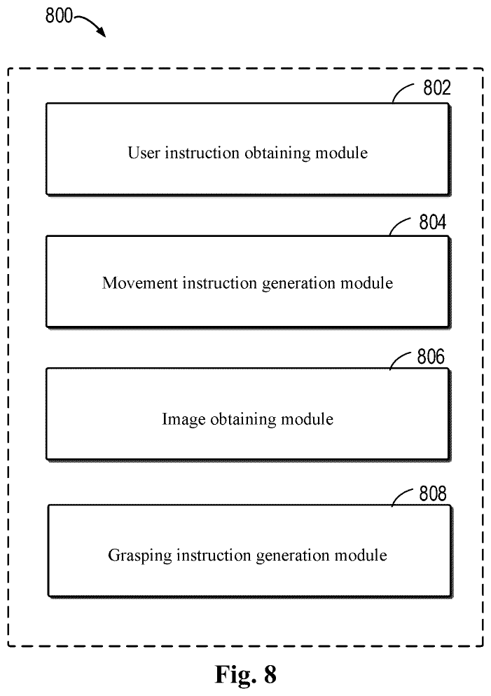

FIG. 8 shows a block diagram of a task execution apparatus 800 according to some embodiments of the present disclosure. As shown in FIG. 8, the apparatus 800 includes a user instruction obtaining module 802, configured to obtain a user instruction represented in a natural language, wherein the user instruction indicates an object to be grasped by a robot. The apparatus 800 further includes a movement instruction generation module 804, configured to generate, using a language model and based on the user instruction, a movement instruction indicating a position at which the object is located, to cause the robot to move to the position. The apparatus 800 further includes an image obtaining module 806, configured to obtain an image obtained at the position. In addition, the apparatus 800 further includes a grasping instruction generation module 808, configured to generate, based on the image, a grasping instruction to cause the robot to grasp the object.

In some embodiments, the movement instruction generation module 804 includes: a prompt generation module, configured to generate, based on the user instruction, a prompt for the language model; and a prompt usage module, configured to generate the movement instruction by inputting the prompt into the language model.

In some embodiments, the prompt generation module includes a task description obtaining module, configured to obtain a task description and an output template; and a task description usage module, configured to generate the prompt based on the task description, the user instruction, and the output template.

In some embodiments, the movement instruction is a first movement instruction, the position is a first position, and the movement instruction generation module 804 includes a second movement instruction generation module, configured to generate, using the language model and based on the user instruction, a plurality of movement instructions, wherein the plurality of movement instructions include the first movement instruction and a second movement instruction, the second movement instruction indicates a second position at which the object is located, and the second movement instruction is used to cause the intelligent robot to move to the second position to grasp the object in response to the robot failing to grasp the object at the first position.

In some embodiments, the task description indicates the language model to generate the plurality of movement instructions, and the task description usage module includes a sorting strategy obtaining module, configured to obtain a predetermined sorting strategy; and a sorting strategy usage module, configured to generate the prompt based on the task description, the sorting strategy, the user instruction, and the output template.

In some embodiments, the sorting strategy is sorting the plurality of movement instructions based on a probability of the object appearing at a corresponding position.

In some embodiments, the sorting strategy is sorting the plurality of movement instructions based on path planning for a plurality of positions corresponding to the plurality of movement instructions.

In some embodiments, the movement instruction includes a coordinate of the position.

In some embodiments, the apparatus 800 further includes an action instruction generation module, configured to generate, using the language model and based on the user instruction, an action instruction associated with the movement instruction, to cause the intelligent robot to perform a specified action included in the action instruction after moving to the position and before grasping the object.

In some embodiments, the grasping instruction generation module 808 includes an attribute determination module, configured to determine, using the language model and based on the user instruction, an attribute of the object; and an attribute usage module configured to generate the grasping instruction based on the image and the attribute of the object.

In some embodiments, the object is a target object, and the attribute usage module includes a category determination module, configured to determine a category of the target object; a category usage module, configured to determine a candidate object in the image based on the category of the target object; a second attribute determination module, configured to determine a value of an attribute of the candidate object; and a second attribute usage module, configured to generate the grasping instruction by determining the candidate object as the target object in response to determining that the value of the attribute of the candidate object matches a value of the attribute specified in the user instruction.

In some embodiments, the language model is a first language model, the object is a target object, and the attribute usage module includes a second category determination module, configured to determine a category of the target object; a second category usage module, configured to determine a plurality of candidate objects in the image based on the category of the target object and the value of the attribute specified in the user instruction; and a second language model usage module, configured to generate, using a second language model and based on the user instruction and the image, the grasping instruction, wherein the grasping instruction includes the target object determined from the plurality of candidate objects.

It may be understood that with the apparatus 800 of the present disclosure, at least one of the advantages achievable by the method or process described above may be achieved. For example, in this way, the natural language processing capability of the robot may be improved by using the understanding capability of the language model, so that the robot may deal with user instructions in various expressions. In this way, users may express their needs more naturally. In addition, by using the reasoning capability of the language model, the robot may deal with user instructions lacking necessary elements, so that users may communicate with the robot in the way they communicate with humans, without having to make sure that the instruction includes all necessary elements before speaking the instruction to the robot. In this way, the solution may not only reduce the cost of enabling the robot to understand the meaning of the user instruction, but also improve the user experience.

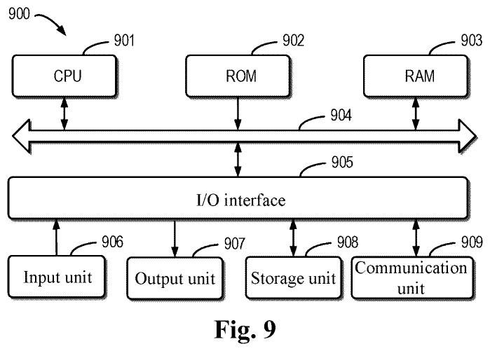

FIG. 9 shows a block diagram of a robot 900 capable of implementing a plurality of embodiments of the present disclosure. The robot 900 may be, for example, the robot 102 shown in FIG. 1. As shown in FIG. 9, the robot 900 includes a central processing unit (CPU) and/or a graphics processing unit (GPU) 901, which may perform various appropriate actions and processing based on computer program instructions stored in a read-only memory (ROM) 902 or computer program instructions loaded from a storage unit 908 into a random access memory (RAM) 903. The RAM 903 may also store various programs and data required for operations of the robot 900. The CPU/GPU 901, the ROM 902, and the RAM 903 are interconnected by means of a bus 904. An input/output (I/O) interface 905 is also connected to the bus 904. Although not shown in FIG. 9, the robot 900 may further include a coprocessor.

A plurality of components in the robot 900 are connected to the I/O interface 905, and the components include: an input unit 906, such as a keyboard, a mouse, etc.; an output unit 907, such as various types of displays, speakers, etc.; the storage unit 908, such as a magnetic disk, an optical disc, etc.; and a communication unit 909, such as a network card, a modem, a wireless communication transceiver, etc. The communication unit 909 allows the robot 900 to exchange information/data with other devices over a computer network such as Internet and/or

### Various Telecommunication Networks.

The various methods or processes described above may be performed by the CPU/GPU 901. For example, in some embodiments, the method may be implemented as a computer software program tangibly contained in a machine-readable medium such as the storage unit 908. In some embodiments, a portion or an entirety of the computer program may be loaded and/or installed into the robot 900 via the ROM 902 and/or the communication unit 909. When the computer program is loaded into the RAM 903 and executed by the CPU/GPU 901, one or more steps or actions in the methods or processes described above may be performed.

In some embodiments, the methods and processes described above may be implemented as a computer program product. The computer program product may include a computer-readable storage medium having computer-readable program instructions for performing various aspects of the present disclosure stored thereon.

The computer-readable storage medium may be a tangible device that may hold and store instructions used by an instruction execution device. The computer-readable storage medium may be, for example, but is not limited to, an electrical storage device, a magnetic storage device, an optical storage device, an electromagnetic storage device, a semiconductor storage device, or any suitable combination thereof. More specific examples (a non-exhaustive list) of the computer-readable storage medium include: a portable computer diskette, a hard disk, a random access memory (RAM), a read-only memory (ROM), an erasable programmable read-only memory (EPROM or flash memory), a static random access memory (SRAM), a portable compact disc read-only memory (CD-ROM), a digital versatile disc (DVD), a memory stick, a floppy disk, a mechanically encoded device such as a punch card or raised structures in a groove with instructions stored thereon, and any suitable combination thereof. The computer-readable storage medium used herein is not interpreted as a transitory signal per se, such as a radio wave or other freely propagating electromagnetic wave, an electromagnetic wave propagating through a waveguide or other transmission medium (for example, a light pulse through an optical fiber cable), or an electrical signal transmitted through a wire.

The computer-readable program instructions described herein may be downloaded from the computer-readable storage medium to various computing/processing devices, or downloaded to an external computer or an external storage device over a network, such as Internet, a local area network, a wide area network, and/or a wireless network. The network may include a copper transmission cable, an optical fiber transmission, a wireless transmission, a router, a firewall, a switch, a gateway computer, and/or an edge server. A network adapter card or a network interface in each computing/processing device receives the computer-readable program instructions from the network, and forwards the computer-readable program instructions for storage in the computer-readable storage medium in the various computing/processing devices.

The computer program instructions for performing the operations of the present disclosure may be assembly instructions, instruction set architecture (ISA) instructions, machine instructions, machine-related instructions, microcode, firmware instructions, state setting data, or source code or object code written in any combination of one or more programming languages, including object-oriented programming languages and conventional procedural programming languages. The computer-readable program instructions may be executed entirely on a user computer, partly on the user computer, as a stand-alone software package, partly on the user computer and partly on a remote computer, or entirely on the remote computer or a server. In the scenario involving the remote computer, the remote computer may be connected to the user computer over any type of network, including a local area network (LAN) or a wide area network (WAN), or may be connected to an external computer (for example, connected over the Internet using an Internet service provider). In some embodiments, by personalizing an electronic circuit, such as a programmable logic circuit, a field programmable gate array (FPGA) or a programmable logic array (PLA), using state information of the computer-readable program instructions, the electronic circuit may execute the computer-readable program instructions, thereby implementing various aspects of the present disclosure.

These computer-readable program instructions may be provided to a processing unit of a general-purpose computer, a special-purpose computer, or other programmable data processing apparatus to produce a machine, so that when these instructions are executed by the processing unit of the computer or other programmable data processing apparatus, an apparatus for implementing the functions/actions specified in one or more blocks in the flowcharts and/or block diagrams is produced. These computer-readable program instructions may also be stored in the computer-readable storage medium, and these instructions cause the computer, the programmable data processing apparatus, and/or other devices to work in a specific manner, so that the computer-readable medium storing the instructions includes a manufactured product, which includes instructions for implementing various aspects of the functions/actions specified in one or more blocks in the flowcharts and/or block diagrams.

The computer-readable program instructions may also be loaded onto a computer, another programmable data processing apparatus, or another device, so that a series of operation steps are performed on the computer, the other programmable data processing apparatus, or the other device to produce a computer-implemented process, so that the instructions executed on the computer, the other programmable data processing apparatus, or the other device implement the functions/actions specified in one or more blocks in the flowcharts and/or block diagrams.

The flowcharts and block diagrams in the drawings show the possibly implemented architectures, functions, and operations of the devices, methods, and computer program products according to a plurality of embodiments of the present disclosure. In this regard, each block in the flowchart or block diagram may represent a module, program segment, or part of instructions, which contains one or more executable instructions for implementing the specified logical functions. In some alternative implementations, the functions marked in the blocks may also occur in an order different from that marked in the drawings. For example, two consecutive blocks may actually be performed substantially in parallel, or they may sometimes be performed in the reverse order, depending on the functions involved. It should also be noted that each block in the block diagrams and/or flowcharts, and a combination of the blocks in the block diagrams and/or flowcharts may be implemented by a special-purpose hardware-based system that executes specified functions or actions, or may be implemented by a combination of special-purpose hardware and computer instructions.

The embodiments of the present disclosure have been described above, and the above description is exemplary, non-exhaustive, and not limited to the disclosed embodiments. Without departing from the scope and spirit of the illustrated embodiments, many modifications and changes will be apparent to those of ordinary skill in the art. The terms used herein are chosen to best explain the principles of the embodiments, the actual application or the technical improvement to the technology in the market, or to enable other persons of ordinary skill in the art to understand the embodiments disclosed herein.

I/We claim:

1. A task execution method, applicable to a robotic system, and comprising:
obtaining an instruction represented in a natural language, the instruction indicating an object to be grasped;
generating a movement instruction using a model based on the instruction and moving to the position, the movement instruction indicating a position at which the object is located;
obtaining an image obtained at the position; and
generating a grasping instruction based on the image and grasping the object.

2. The method of claim 1, wherein generating the movement instruction using a model based on the instruction comprises:
generating a prompt for the model based on the instruction; and
generating the movement instruction by inputting the prompt into the model.

3. The method of claim 2, wherein generating the prompt for the model based on the instruction comprises:
obtaining a task description and an output template; and
generating the prompt based on the task description, the instruction, and the output template.

4. The method of claim 3, wherein the movement instruction is a first movement instruction, the position is a first position, and wherein generating the movement instruction using a model based on the instruction comprises:
generating a plurality of movement instructions using the model and based on the instruction, wherein the plurality of movement instructions comprise the first movement instruction and a second movement instruction, the second movement instruction indicates a second position at which the object is located, and the second movement instruction is used to cause the robotic system to move to the second position to grasp the object in response to the robotic system failing to grasp the object at the first position.

5. The method of claim 4, wherein the task description indicates the model to generate the plurality of movement instructions, and wherein generating the prompt based on the task description, the instruction, and the output template comprises:
obtaining a predetermined sorting strategy; and
generating the prompt based on the task description, the sorting strategy, the instruction, and the output template.

6. The method of claim 5, wherein the sorting strategy is sorting, based on a probability of the object appearing at a corresponding position, the plurality of movement instructions.

7. The method of claim 5, wherein the sorting strategy is sorting, based on path planning for a plurality of positions corresponding to the plurality of movement instructions, the plurality of movement instructions.

8. The method of claim 1, wherein the movement instruction comprises a coordinate of the position.

9. The method of claim 1, further comprising:
generating, an action instruction using the model and based on the instruction, the action instruction being associated with the movement instruction, and performing a specified action comprised in the action instruction after moving to the position and before grasping the object.

10. The method of claim 1, wherein generating the grasping instruction based on the image comprises:
obtaining an attribute of the object using the model based on the instruction; and
generating the grasping instruction based on the image and the attribute of the object.

11. The method of claim 10, wherein the object is a first object, and wherein generating the grasping instruction based on the image and the attribute of the object comprises:
obtaining a category of the first object;
obtaining, based on the category of the first object, a candidate object in the image;
obtaining a value of the attribute of the candidate object; and
generating the grasping instruction by obtaining the candidate object as the first object in response to obtaining that the value of the attribute of the candidate object matches a value of the attribute specified in the instruction.

12. The method of claim 10, wherein the model is a first model, the object is a first object, and wherein generating the grasping instruction based on the image and the attribute of the object comprises:
obtaining a category of the first object;
obtaining, based on the category of the first object and a value of the attribute specified in the instruction, a plurality of candidate objects in the image; and
generating the grasping instruction using a second model based on the instruction and the image, wherein the grasping instruction comprises the first object obtained from the plurality of candidate objects.

13. A robotic system, comprising:
a processor; and
a memory coupled to the processor, the memory having instructions stored thereon, the instructions, when executed by the processor, causing the robotic system to:
obtain an instruction represented in a natural language, the instruction indicating an object to be grasped;
generate a movement instruction using a model based on the instruction and move to the position, the movement instruction indicating a position at which the object is located;
obtain an image obtained at the position; and
generate a grasping instruction based on the image and grasping the object.

14. The robotic system of claim 13, wherein the instructions causing the robotic system to generate the movement instruction using a model based on the instruction further cause the robotic system to:
generate a prompt for the model based on the instruction; and
generate the movement instruction by inputting the prompt into the model.

15. The robotic system of claim 14, wherein the instructions causing the robotic system to generate the prompt for the model based on the instruction further cause the robotic system to:
obtain a task description and an output template; and
generate the prompt based on the task description, the instruction, and the output template.

16. The robotic system of claim 15, wherein the movement instruction is a first movement instruction, the position is a first position, and wherein the instructions causing the robotic system to generate the movement instruction using the model and based on the instruction further cause the robotic system to:
generate a plurality of movement instructions using the model and based on the instruction, wherein the plurality of movement instructions comprise the first movement instruction and a second movement instruction, the second movement instruction indicates a second position at which the object is located, and the second movement instruction is used to cause the robotic system to move to the second position to grasp the object in response to the robotic system failing to grasp the object at the first position.

17. The robotic system of claim 16, wherein the task description indicates the model to generate the plurality of movement instructions, and wherein the instructions causing the robotic system to generate the prompt based on the task description, the instruction, and the output template further cause the robotic system to:
obtain a predetermined sorting strategy; and
generate the prompt based on the task description, the sorting strategy, the instruction, and the output template.

18. The robotic system of claim 17, wherein the sorting strategy is sorting, based on a probability of the object appearing at a corresponding position, the plurality of movement instructions.

19. The robotic system of claim 17, wherein the sorting strategy is sorting, based on path planning for a plurality of positions corresponding to the plurality of movement instructions, the plurality of movement instructions.

20. A computer program product, tangibly stored on a non-transitory computer-readable medium and comprising machine-executable instructions, the machine-executable instructions, when executed by a machine, causing the machine to:
obtain an instruction represented in a natural language, the instruction indicating an object to be grasped;
generate a movement instruction using a model based on the instruction and move to the position, the movement instruction indicating a position at which the object is located;
obtain an image obtained at the position; and
generate a grasping instruction based on the image and grasping the object.
